(19) United States
(12) Patent Application Publication
(10) Pub. No.: US 2002/0133347 A1
(43) Pub. Date: Sep. 19, 2002

(54) Method and apparatus for natural language dialog interface

(76) Inventors: Eberhard Schoneburg, Boston, MA (US); Fabian Donze, North Easton, MA (US); Klaus Kater, Gruenenbach (DE)

Correspondence Address: MINTZ, LEVIN, COHN, FERRIS,, GLOVSKY and POPEO, P.C., One Financial Center, Boston, MA, 02111, US

(21) Appl. No.: 09/921,826

(22) Filed: Aug. 3, 2001

Related U.S. Application Data
(63) Continuation of application No. 09/752,338, filed on Dec. 29, 2000.

(51) Int. Cl. G10L 15/18

(52) U.S. Cl. 704/257

(57) ABSTRACT

A system for interactive dialog management between a user and a computer system is provided. The system includes an input interface, a preprocessing module, a pattern knowledge database, a pattern recognition module, first, second and third control modules. and an output interface. The input interface receives an input phrase from a user and the preprocessing module converts the received input phrase into at least one pattern. The pattern knowledge database stores a plurality of patterns, each pattern comprising at least one element selected from the group consisting of words, phrases, and combinations of words and phrases. The pattern recognition module identifies elements in the converted input phrase, and locates at least one matching pattern in the pattern knowledge database. In response to each matching pattern in the input phrase, the first control module creates a plurality of potential outputs based upon the matching pattern and at least one rule. The second control module defines at least one condition for selection of a potential output from the plurality of potential outputs. The third control module interprets the input phrase, selecting an output, and generating a response in accordance with information provided by the pattern recognition module and the first and second control modules. The output interface provides the response to the user.

### BACKGROUND OF THE INVENTION

1. Field of the Invention

The present invention relates to the field of interactive computer interfaces, and more specifically to the field of natural language interfaces designed to interface human users and computing entities on the Internet with computer systems pertaining to the class of Information systems.

2. Discussion of Related Art

There are a variety of dialog computer systems which act as mediators between a human user and a knowledge system. However, the difficulty with such systems is the inability to access the knowledge system in a simple yet reliable and non-contradictory way. The world is booming with information technologies. People often attempt to obtain specific information they are interested in. While the information may be available, they sometimes fail to obtain it because they ask a question or express their intentions in a way which results in misunderstanding between them and the system having the information. Additionally, a response can be so ambiguous and so exceed the user's knowledge that neither the user nor the system is unable to determine any relationship between the previously asked question, the response and subsequent user requests. Such a result can cause failures of the system and inability of the user to obtain the information or proceed with seeking it from that source.

Furthermore, such dialog systems are often very sensitive to a user's grammar and stylistic skills. Even for systems using natural language, differences in grammar, style, and idioms may result in misunderstandings. Such systems are unable to take into account the user's psychophysical (emotional) state in determining the meaning of requests, which also influences the adequacy of answers by the system. These abilities may not be crucial in pure information systems with a menu-based structure of knowledge, or in expert systems acting mainly as consulting-diagnostic systems and containing a super complex hierarchy of objects and relations between them describing a knowledge domain. They are, on the other hand, very important for the purpose of improving the quality of a dialog. In a real dialog, a person catches only a part of information by using his/her listening abilities and the rest is caught by means of the context, his/her personal experience, interlocutor's reaction including an emotional state and a variety of other factors. Therefore, a need exists for a system which can perform a dialog with a user to obtain desired information. A need further exists for a system which can use clues other than simply the current statement to determine the meaning of a request as part of the dialog. A need further exists for a system which can provide an answer within the context of the user's requests.

Some dialog systems may collect a user's profile to be used in determining meaning for requests. However, such profiles are often obtained through a method similar to the one used for filling out a questionnaire with a fixed two-valued or multiple-valued system with a further possibility of altering only a minor part of the system. This approach is simple but ineffective for those systems which are required to support the user's current profile in order to realize his/her preferences and desires. Therefore, it prevents the systems from being adjusted to their interlocutors automatically which is especially important for entertainment-type systems. This disadvantage is followed by another one relating to the predominance of the internal goals implemented at the stage of designing and according to which systems of the above types operate. This is also an obstacle for these systems to be adapted to a user's needs and can be a cause of misunderstanding between the user and the system. Therefore, a need exists for a system which can incorporate present and past user information in carrying out a dialog and determining the meaning of requests.

### SUMMARY OF THE INVENTION

The above and other features are achieved with a universal dialog computer system which is capable of receiving user-defined queries in the form of a phrase in a natural language or in constrained variants. The user-defined query is read into the short-term memory device and parsed to delineate specific cases connected with different lists of punctuation characters and single and multiple word character strings. The content of these lists is successively compared with the content of the short-term memory device in order to identify important elements in the user-defined character string and the system looks for the best matches between these elements and patterns in pattern knowledge bases which are a part of the knowledge bases. The attributes of the identified patterns used as references as well as the history of the current and previous conversations are used for selecting potential answers from the associated actions base which is also a part of the knowledge bases. The best answer is chosen by a sequential calling of different mechanisms with the calling being determined by predefined sets of rules of the central processing block. The method required for information processing in each mechanism is also determined by its own pre-defined set of rules. The best system answer from the viewpoint of history, correspondence of input/output types, goal, emotions and other parameters is presented to the user in response to his/her query.

In accordance with one embodiment, the present invention discloses a universal dialog computer system having an interactive user interface for receiving a user phrase, memory for storing information about the user in the process of a conversation and for storing the knowledge about pre-defined domains. The computer system further contains subsystems responsive to the user phrase for processing received information and selecting a set of internal segments which correspond to the phrase according to a predefined criteria; a subsystem responsive to the set of internal segments for selecting the best one according to another set of rules; and then it contains subsystems responsive to the most appropriate internal segment for selecting one of the most adequate responses which correspond to the chosen information segment according to predefined sets of rules. The system further contains a subsystem for presenting the selected answer to the user.

In another embodiment, the invention discloses a method for processing information entered by a user, including steps of receiving the user phrase; selecting a set of the internal segments corresponding to the query with defining the best segment which is the most appropriate for the phrase according a predetermined criteria and a set of rules; selecting the most adequate system response which is in the given information segment according to other sets of rules; and presenting an answer to the user, in response to his/her query.

In yet another embodiment, the invention discloses a computer program product for use with a computer system having a need in the implementation of an interactive user interface. The computer program product includes a computer useable media having program code embodiment in the medium for enabling a user to obtain information from the universal computer system with queries in natural language or any its constrained variants. The program code is responsive to a query in the form mentioned for identifying important elements of the query presented as a set of internal segments. The program code further selects the best internal segment from the set in accordance with a predefined criteria, and, selects the most adequate response which being in the given information segment corresponds to the query and is defined by the conversation history, correspondence of input/output types, goal, emotions and other parameters from the predetermined sets of rules.

### BRIEF DESCRIPTION OF DRAWINGS

FIG. 1 is a block diagram of the architecture of an embodiment of the present invention.

FIG. 2 is a block flow diagram of the process in the preprocessor module of the architecture of FIG. 1.

FIG. 3 illustrates a structure for a sample set of patterns.

FIG. 4 is a process diagram for the pattern recognition module of the architecture of FIG. 1.

FIG. 5 is a block flow diagram of the initialization process in the pattern recognition module of the architecture of FIG. 1.

FIG. 6 is a block flow diagram of a pattern addition process in the pattern recognition module of the architecture of FIG. 1.

FIG. 7 is a block flow diagram of a pattern addition process in the pattern recognition module of the architecture of FIG. 1.

FIG. 8 is a process diagram for the spell checking process in the pattern recognition module of the architecture of FIG. 1.

FIGS. 9a and 9b are block flow diagrams of the matching process in the pattern recognition module of the architecture of FIG. 1.

FIG. 10 is a block flow diagram of the process in the meta-control and discourse control modules of the architecture of FIG. 1.

FIG. 11 is a block flow diagram of the process for determining a best system output.

FIG. 12 is block diagram of the interaction of the goal control module of the architecture of FIG. 1.

FIG. 13 is a block flow diagram of process for determining a best system output.

FIG. 14 illustrates the emotions control mechanism of the architecture of FIG. 1.

FIG. 15 is a block flow diagram of determining a best system output using emotional content.

FIG. 16 is a block flow diagram of the operation of the actions retrieval and output interface modules of the architecture of FIG. 1.

FIG. 17 illustrates the structure of the short-term memory device.

### DETAILED DESCRIPTION

The present invention is a universal dialog computer system for transforming a user's phrase presented in the form of a natural language utterance into an adequate response by the system which is also presented in natural language and accompanied by the performance of a number of required actions. The system is separated into two parts: a processing mechanism and a knowledge base. The processing mechanism uses the knowledge base to parse the natural language phrase to determine meaning within the context of a specific user. The knowledge base is developed as more information becomes available to the processing mechanism during dialogs. Additionally, the knowledge base can be designed to be modified and expanded by the system user. The user can write his/her own knowledge base source files and then import them into the considered system by means of a special tool transforming knowledge into a form which can be understood by the mechanism, but he/she cannot alter the predefined hierarchical structure of knowledge responsible for correct operation of the whole system. This option enables the system to reflect the most recent knowledge changes and be kept up-to-date according to the user's preferences.

The knowledge base provides a relationship between user inputs and system responses. The knowledge base can be organized according to topics within three main types: general, special, and default. General topics, represented as FALLBACK and REFERENCE, are created by the system with respect to dialogs. Specific topics are developed according to the user's requirements. Finally, default topics, represented as O BJECT, are developed for conducting a dialog. Information about the structure is kept in the form of solid interfaces to knowledge or abstract classes, in terms of object-oriented programming (OOP). All real knowledge that comes from the knowledge base source files through the process of generation is delivered to the mechanism in the form of these abstract classes. Moreover, in one embodiment of the present invention, the whole system is implemented as abstract interfaces in terms of OOP. This type of software implementation is well known in the art of data processing, and thus, is not described in detail herein. In any event, the present invention does not rely upon any particular means by which the system is made available to a knowledge engineer or an application programmer.

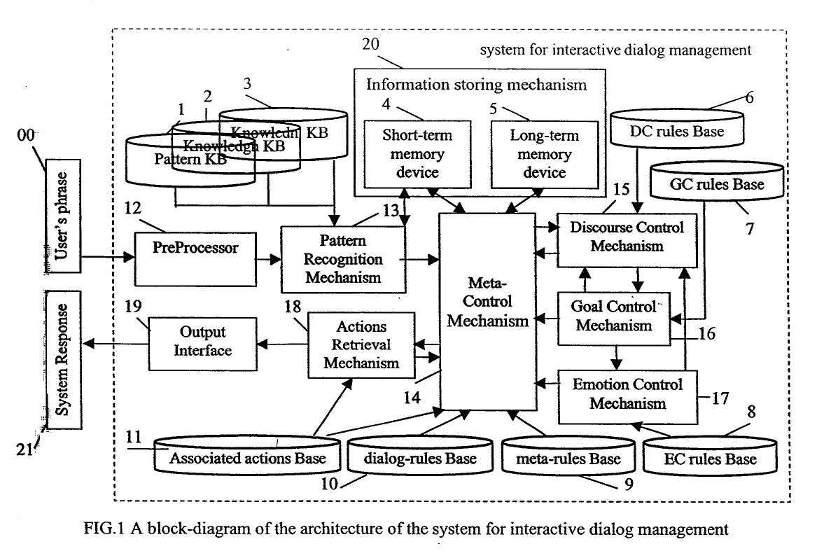

FIG. 1 is a block diagram illustrating one embodiment of a dialog computer system according to the present invention. The various parts of the system can be implemented on a single computer system with appropriate programming. It could be implemented in any number of computer programming languages, including Java or other object-oriented type programming languages. The process of parsing a user's phrase and selecting an appropriate response can be divided into several major operations, that are shown in FIG. 1 as separate modules. The operation of the system will be described in conjunction with the processes in each of these modules.

To implement the process, a session object is created and stored in the short-term memory device 4. The session object links all processes in the system and defines a unique current contact for every user, including a list of topic instances. A static cache list is maintained to prevent the creation of redundant topic instances. This is important because the topics do not contain session specific data. The content of the static cache list is determined an initialization file of the system indicating which pattern knowledge bases should be available to the mechanisms of the system during a conversation.

First, the preprocessor 12 receives and prepares a user's natural language phrase 00 to be processed by the other modules of the system. The user's phrase can be received in a variety of ways, including inputted on a keyboard or through voice recognition. Additionally, the phrase may be of some form on constrained natural language, such as brief phrases, menu-type phrases, and commands. For purposes of the embodiment of the present invention, it is sufficient if the user's phrase is any sequence of words or symbols reflecting an user's intended statement or response. In general, the pre-processor 12 prepares a user's phrase for the next module—pattern recognition mechanism 13. The preprocessor module 12 removes extraneous information, such as special, unconventional cases and special non-dividable phrases and prefixes. Items such as titles and URL addresses are processed and translated into a form that can be understood by the pattern recognition mechanism 13.

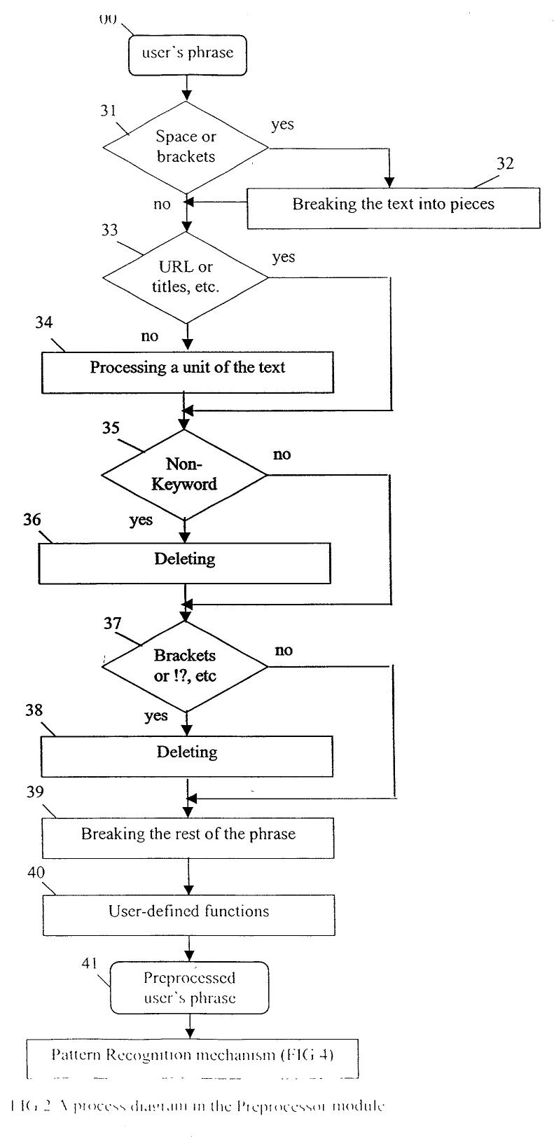

The processes performed in the preprocessor module 12 are illustrated in FIG. 2. First, the preprocessor breaks the user phrase into the units of the text, separated by spaces and characters such as “[“,”]”, “(“, ”)” (step 32). At step 34, the preprocessor 12 prevents the separation of those pieces of the text that should not be changed, for example URL addresses, titles (like “Mr.”, “i.e.”), if necessary. At steps 35-38, the preprocessor 12 removes those parts of the text that are not keywords in the pattern. Non-keywords may includes words or punctuation marks. The remaining part of the user's phrase is separated into parts to be parsed (step 39). The parts can be separated by special characters, such as “.”, “-”, “>”, etc. Finally, the preprocessor may implement any user-defined functions (step 40). The ability to add user-defined functions increases the personalization and accommodates the idiosyncrasies of each user. Once the user's phrase has been preprocessed, it is passed to the pattern recognition module 13.

The pattern recognition mechanism 13 identifies important elements in the input phrase and looks for the best matches between these elements and the patterns in the pattern knowledge bases 1-3, using special expression-pattern matching techniques. It then retrieves user input objects linked with the selected patterns from the pattern knowledge bases 1-3. The user input objects define the topic of the user's phrase, the intention conveyed by the user utterance and topic properties, which describe the content of the phrase as understood by the pattern recognition module 13. The pattern matching process is generally illustrated in FIG. 4. The function can be separated into two main parts: match data building 45 and matching with particular match data 46. A spell checking process 47 can be used as part of the particular data matching 46.

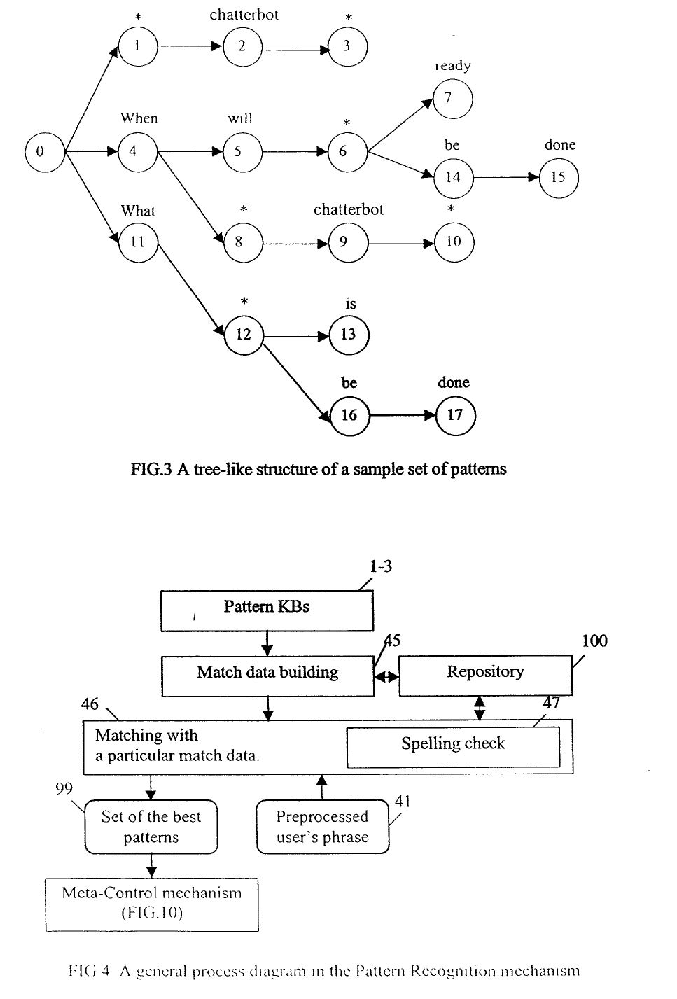

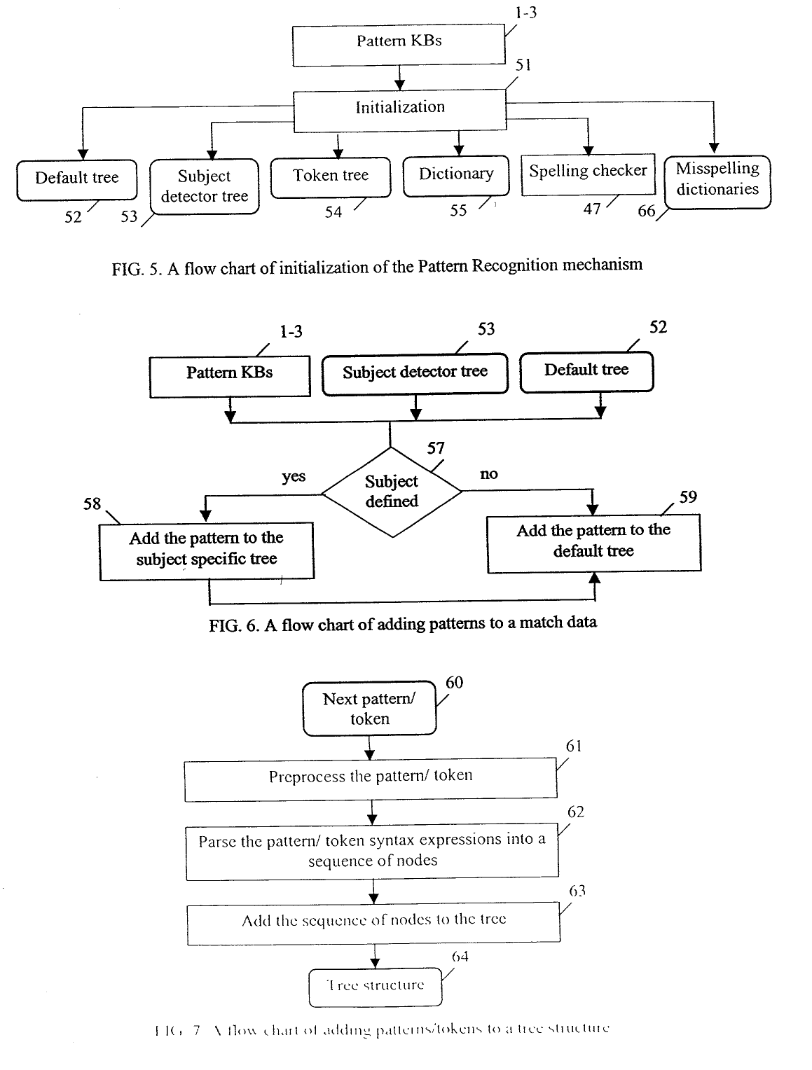

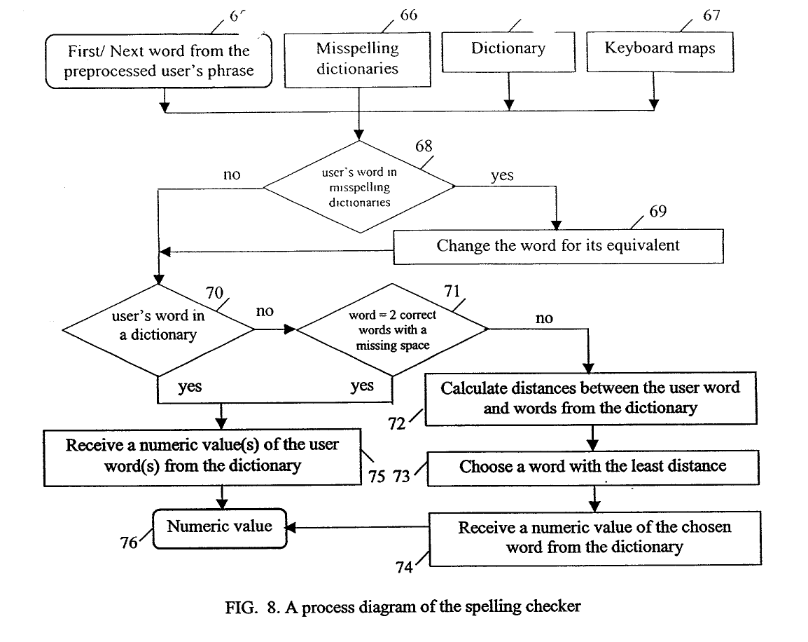

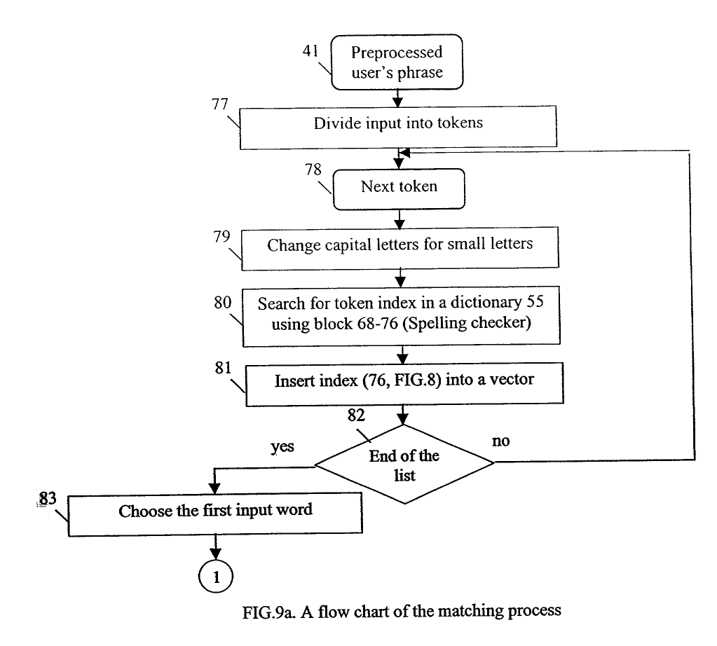

FIGS. 5-7 illustrate the processes for initialization of the pattern recognition mechanism 13 from the pattern information in the knowledge bases 1-3. At the stage of initialization (step 51), the pattern recognition mechanism 13 uses the patterns in the knowledge bases 1-3 to create pattern trees. A default dictionary 55 is created by using the customer's dictionaries or general dictionaries for the system. The pattern trees include a subject detector tree 53, a default tree 52, a token tree 54, and any subject specific trees. The processes for creating trees are illustrated in FIGS. 6 and 7. The subject detector tree 53 is composed of the existent subjects. Each subject has a separate specific tree. A pattern is checked (step 57) to determine whether it has a specific subject. If the pattern has its own defined subject it is entered in the subject specific trees (step 58). All patterns, with or without a subject, are also entered into the default tree (step 59). The process for entering a pattern on a tree is illustrated in FIG. 8. The pattern is parsed into a sequence of individual nodes (step 62). The nodes are added to the tree in order (step 63). After entering either of the trees, the patterns with similar beginnings share a common path in the tree structure, taking different branches at the points where they differ. For example, FIG. 3 illustrates a tree structure for the following set of patterns:

* chatterbot *
When will * ready
When * chatterbot *
What * is
When will * be done
What * be done

Each phrase is represented by a path from the root to an end of the tree structure. The numbers in the nodes represent the order in which the nodes were created from the patterns listed above. The “*” character is a wildcard, which can represent any arbitrary sequence of words or symbols in a user phrase. Also available are star-words and tokens as extensions of words and wildcards, and which organize sub-trees on the nodes. Star-words are words in which some letters are substituted by wildcards. For example, invest* can stand for investor, investing, investment, etc. Tokens are lists of interchangeable phrases, star-words or wildcards. For example, choices such as “chatter bot|chatterbot”, can be a token. Each time a pattern or token is added to the match data it is parsed into a sequence of nodes and added to a tree. To speed up the process of matching, the words in the tree are represented by their unique numbers assigned to them at the initialization stage. The word and corresponding number information is written in the default dictionary 55 (FIG. 5), which is stored in a repository 100 (FIG. 4) as a part of the short-term memory device 4 (FIG. 1). When a user utterance is given for matching, the words of this utterance are also converted into numbers with the help of the same dictionaries. Thus, while traversing a tree and exploring every possible path, only a quick comparison of numbers is needed instead of a multiple time-consuming comparison of character strings. It enables a super-rapid identification of the closely matching patterns out of thousands of candidates, which are stored by means of a highly optimized way in terms of the space and matching speed. Also defined is the type of a language-specific match data upon which the required keyboard maps 68 are dependent.

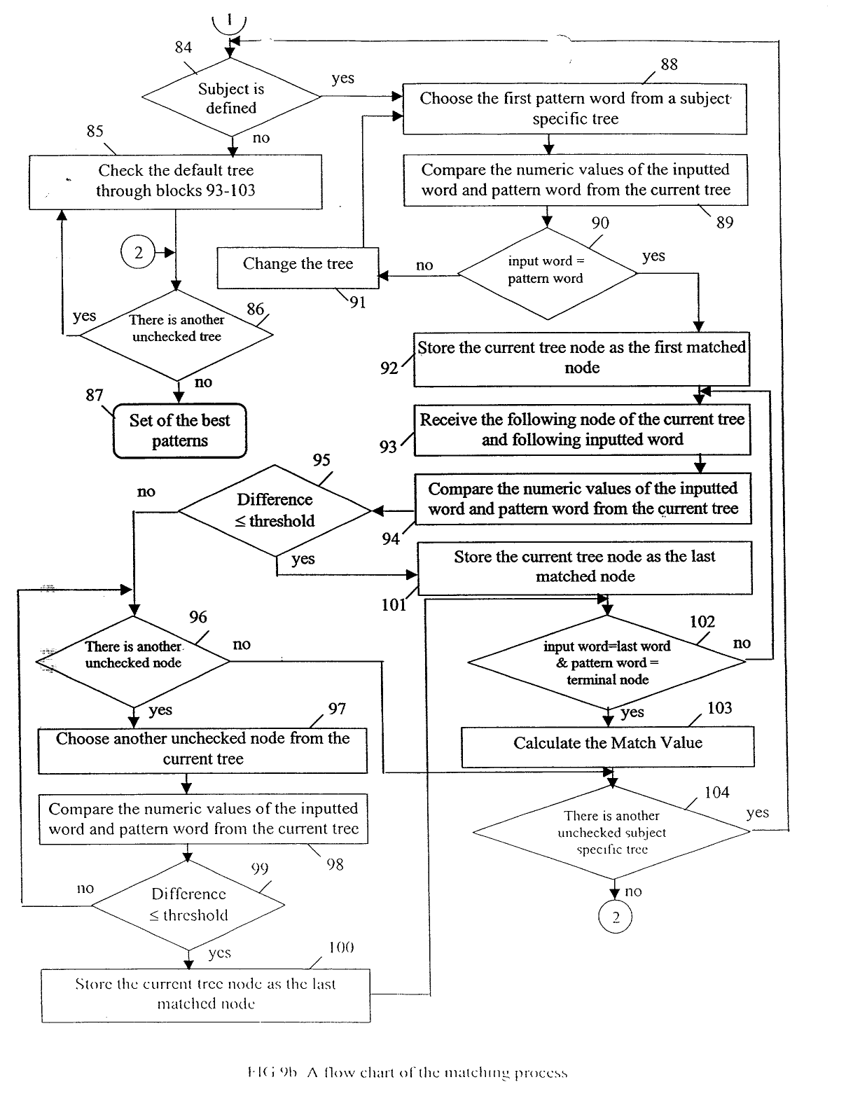

FIGS. 8, 9a and 9b illustrate the process in the pattern recognition module 13 of matching a user phrase 41 (from the preprocessor 12) with the match data distributed on the trees. The system includes a spelling checker in order to broaden the matching process. If the spelling checker is on, rather than a strict comparison between the node and the words in the phrase, a distance between the node and each of the words in the user phrase is calculated. If the distance falls into a specified range, a vector, consisting of two elements: the node word and the distance between it and the user word, is returned as a trace. The distance is calculated by the spelling checker using a common spelling algorithm and some rules, as illustrated in FIG. 8.

Using the user or default dictionary 55 and predefined keyboard maps 67, the spell checker builds a numeric equivalent of the user phrase. The spelling checker receives a word from the preprocessed user's phrase and checks if the word is included in the dictionary (70). If the word is in the dictionary, its numeric value is retrieved (step 75). Otherwise, it checks whether the word consists of two correct words from the dictionary 55 with the missing space between them (step 71). If it is true, then it inserts a space and proceeds to retrieve the numeric value for the words (step 75).

At this stage the normalization of the word including recognizing its suffix and checking the correctness of the word remaining after its suffix is detached can be done. Usually, word normalization is used for decreasing the number of words in a dictionary and for increasing the speed of processing of the whole phrase in the spelling checker 47, respectively. Otherwise it defines the “nearest” words in the dictionary and replaces the incorrect word by the word the spelling of which is the closest to it (steps 72-74). To define this word the spelling checker 47 calculates the distance between the user word and each word from the dictionary by means of a special set of numbers which is used for defining weights of letters according to the position of the keys on a keyboard. The set of numbers is presented bellow only for the English keyboard map. The English language is selected as natural language only for illustrative purpose. However, it will be understood by anyone reasonably skilled in the arts that any language may be used as long as appropriate keyboard maps are used.

TABLE 1
Letter's weights used for spelling-check

| | Row | Column | | Row | Column | | Row | Column |
|---|---|---|---|---|---|---|---|---|
| Letter | weight | weight | Letter | weight | weight | Letter | weight | weight |
| A | 2 | 1 | J | 2 | 7 | S | 2 | 2 |
| B | 3 | 5 | K | 2 | 8 | T | 1 | 5 |
| C | 3 | 3 | L | 2 | 9 | U | 1 | 6 |
| D | 2 | 3 | M | 3 | 7 | V | 3 | 4 |
| E | 1 | 3 | N | 3 | 6 | W | 1 | 2 |
| F | 2 | 4 | O | 1 | 9 | X | 3 | 2 |
| G | 2 | 5 | P | 1 | 10 | Y | 1 | 6 |
| H | 2 | 6 | Q | 1 | 1 | Z | 3 | 1 |
| I | 1 | 8 | R | 1 | 4 | 4 | 2 | 11 |

The degree of similarity of words s1 and s2 is calculated as

$${f}_{S} ( s1 , s2 ) = {f}_{L} ( {a}_{1} , {b}_{1} ) + {d}_{1} {f}_{L} ( {a}_{2} , {b}_{1} ) + {\sum }_{i = 2}^{n - 1} [ {f}_{L} ( {a}_{j} , {b}_{i} ) + \frac{{f}_{L} ( {a}_{j - 1} , {b}_{i} ) + {f}_{L} ( {a}_{j + l} , {b}_{i} )}{{d}_{2}} ] + {f}_{L} ( {a}_{n} , {b}_{n} ) + {d}_{1} {f}_{L} ( {a}_{n} , {b}_{n - 1} )$$

where j=i·round

$$( \frac{l}{n} ) ; l$$

the length of word s2; n—the length of word s1; a₁—a letter with a number i in word s1; bᵢ—a letter with a number i in word s2; d₁, d₂−coefficients defining the accuracy of the word overlap; f_{L}(a,b)—the relative distance between letters which is calculated as follows

$${f}_{L} ( a , b ) = \{ \begin{matrix} 1 , if a = b ; \\ {d}_{3} , if ( ( a {=}^{′} {s}^{′} ) and ( b {=}^{′} {c}^{′} ) ) or ( ( a {=}^{′} {c}^{′} ) and ( b {=}^{′} {s}^{′} ) ) ; \\ \frac{{d}_{3}}{\vert r ( a ) - r ( b ) \vert + \vert c ( a ) - c ( b ) \vert} .\end{matrix}$$

where r(a), r(b)—the row weight for letters a and b; c(a), c(b)—the column weight for letters a and b; d₃—coefficient defining the accuracy of the letter overlap.

The distance between all of the words in the dictionary and the present word from the user phrase are determined (step 72). Then, the word with the least distance is selected at step 73. The numeric value of the selected word is used for the word in the user phrase (step 74).

The matching process is illustrated in FIGS. 9a and 9b. The process starts at step 77 in FIG. 9a. First, the user's phrase is divided into tokens. As noted above, a token is a set of words or phrases. Each token is processed separately (steps 79-81) until all of the tokens in the phrase have been processed (step 82). In processing the tokens, capital letters are changed to lower case letters (step 79) and the spell checking process (step 80), described above and illustrated in FIG. 8, is used to determine a closest match for the token in the dictionaries. The numeric value or index is entered into a vector (step 81) for each token). The list of numeric values is then used for the matching process, as illustrated in FIG. 9b.

First, the module checks if the user phrase contains a subject as determined by the preprocessor 12 (step 84). Depending on the results, either a particular subject tree (step 88) or the default tree (step 85) is used for the remaining matching process. The node word of the selected tree is compared to the first word of the phrase to determine whether it is present (step 89). If the words match (step 90), the comparison of that tree continues (steps 92-103).

Otherwise, a new tree is selected (step 91). As noted above, in order to determine whether a word matches a node, the word is looked up in the dictionary. The corresponding numeric value is compared to the node values. If the node word matches a word from the user phrase, the matched word is returned as a trace and its value is pushed into the stack (step 92). Then the sub-trees of the node are considered. The next node is compared to the next word in the user phrase (step 94). If they match (defined as within a specified distance), that node is also stored on the stack (step 101) and the process is repeated for the remaining words on the sub-tree (step 102). If the words do not match, another node is checked (steps 96-99). If a subsequently checked node matches with the second word, it is pushed onto the stack (step 100) and the sub-trees of that node are checked. If no nodes match the next word in the user phrase, then the system proceeds to the next tree (step 104). In this manner, all of the trees and nodes are compared with the words in the user phrase. If all of the words in the user phrase match with nodes in a tree, in order and of the same length, a match value is calculated for the tree (step 102). Otherwise, the system proceeds to consider other trees.

Since there can be many possible matches, the system checks and explores all the available paths until it reaches the point where a non-matching node appears. A Match Value is calculated as a total sum of weight coefficients where each separately taken coefficient defines the ratio between a certain template element and the existent pattern knowledge bases 1-3 with the help of the following formula:

MV=word_count+C_{rw}mv_{rw}+Cₛₐmvₛₐ+C_{wc}mv_{wc}+C_{sw}mv_{sw}+C_{tc}mv_{tc}, where MV is a Match Value;

mv_{rw}=word_count/(word_count+wildcards_count);

mvₛₐ=(e+non_empty_wildcards_count)/(e+wildcard_absorbed_count);

mv_{wc}=(e+non_empty_wildcards_count)/(e+wildcards_count);

mv_{sw}=1−(e+star_word_count)/(e+word_count);

mv_{tc}=1−Π(word_distanceᵢ), i=0 . . . word_count.

C_{rw}, Cₛₐ, C_{sw}, C_{tc}−weight coefficients (in the range of 0 . . . 0.9) for each component provided C_{rw}>Cₛₐ>C_{wc}>C_{sw}>C_{tc} which can be approximated in the process of implementation; word_count is the number of words of a pattern;

wildcards_count is the number of wildcards of a pattern;

non_empty_wildcards_count is the number of wildcards that have been used;

wildcard_absorbed count is the number of words that are included into non_empty_wildcards_count;

star_word_count is the number of star-words in the same pattern.

The value of mv_{sw} is changed from 0 (provided all matched words are star-words) to 1 (provided no star-words have been matched).

After a Match Value has been calculated by means of the pattern recognition mechanism 13, it can be modified with the help of the information received from the preprocessor 12 with the calculation being dependent on such a characteristic as a Subject priority in a pattern KB and a KB priority. The updating of the value is carried out in the following way:

MV=MV+Cₛ*subject_priority,

MV=Cₚᵣ*MV*kb_priority,

where Cₛ and Cₚᵣ are the weight coefficients from 0 to 0.9 provided Cₛ>Cₚᵣ.

Besides, the two descriptive values that provide the evaluation of the matched patterns by using the two criteria—Confidence and Completeness are calculated and normalized to enable knowledge engineers to evaluate the quality of the mechanism. These values do not affect the process of pattern recognition and are calculated in the following way:

MatchConfidence Value=C_{rw}*(word_count (word_count+wildcards_count))+Cₛₐ*((e+non_empty_wildcards count)/(e+wildcard_absorbed_count))+C_{wc}*((e+non_empty wildcards_count)/(e+wildcards_count))+C_{sw}*(1−(e+star_word_count)/(e+word_count))+C_{tc}*(1−typos);

MatchCompletnessValue=C_{rw}*((e+non_empty_wildcards_count)/(e+wildcards_count))+Cₛₐ*((e+non_empty_wildcards_count)/(e+wildcard_absorbed_count))+C_{wc}*(word_count/(word_count+wildcards_count))+C_{sw}*(1−(e+star_word_count)/(e+word_count))+C_{tc}*(1−typos);

where typos=529 (word_distanceᵢ), i=0 . . . word_count.

This method can be illustrated in the following example for the phrase “Tell me about St-Petersburg”:

Pattern: * St*Peters*urg *

The pattern analysis is presented as follows:

| | |
|---|---|
| WORD COUNT: | 1.0 |
| NON-EMPTY WILCARDS: | 1.0 |
| ABSORBED WILCARDS: | 3.0 |
| WILCARDS COUNT: | 2.0 |
| STARWORDS COUNT: | 2.0 |
| MATCH VALUE: | 1.334592224922086 |

If for the “Tell me about St-Petersburg” utterance the pattern recognition mechanism 13 has found the following pattern:

Pattern: *

Then the analysis of this expression is presented as follows:

| | |
|---|---|
| WORD COUNT: | 0.0 |
| NON-EMPTY WILCARDS: | 1.0 |
| ABSORBED WILCARDS: | 4.0 |
| WILCARDS COUNT: | 1.0 |
| STARWORDS COUNT: | 0.0 |
| MATCH VALUE: | 0.03159168745781356 |

If for the “Tell me about St-Petersburg” utterance the pattern recognition mechanism 13 has found a pattern which is included into user input accompanied by a subject parameter which equals to 80, then the obtained Match Value is modified as follows:

MATCH VALUE: 1.334592224922086+0.001*80=1.41459222492208

If the found pattern has a KB priority parameter equal to 70 then the MatchValue is calculated as follows:

MATCH VALUE: 1.334592224922086 * 0.01*70=0.934214557445456

The chosen candidates having the maximum Match Value are considered the most suitable hypotheses of what the user is interested in, but they are devoid of a context so far. That is why, these candidates are sent to the next module—the meta-control mechanism 14.

The meta-control mechanism 14 coordinates work of the information storing mechanism 20 and manages the context of a dialog by using meta-rules from the meta-control rules base 9, dialog rules from the dialog rules base 10 and information from the discourse control mechanism 15, the goal control mechanism 16 and emotion control mechanism 17 to mark a subsequent system output. It is the brain of the whole system. It receives a set of hypotheses generated by the pattern recognition mechanism 13, and calls other components in order to determine the most appropriate response or the “next move” of the whole system.

At this stage the base strategy is to stay in the same topic, but the main strategy is to follow the common dialog scenarios. If the base behavior of the system is defined by the dialog rules, the main one is defined by meta-rules, which will be considered in more detail in the next paragraphs.

Context, as contained in the short-term memory device 4, is important in understanding the meaning of user phrases. For example, if the mechanism knows that the system has just been asked a question, then a subsequent input from the user cannot be marked as “reply to a question”. Similarly, if the system has just asked a question, then the topic-centric arrangement of the patterns in the knowledge base gives the meta-control mechanism the clue it needs to recognize if the user gives a response that might be very generic—outside the context, but specific for a particular situation. For instance, the word “yes” is virtually meaningless without a context, but as an answer to a specific question it is extremely important if it matches the context of that question. Thus, the mechanism can recognize situations of the type and hence filter out untenable hypotheses, keeping only the most appropriate candidates.

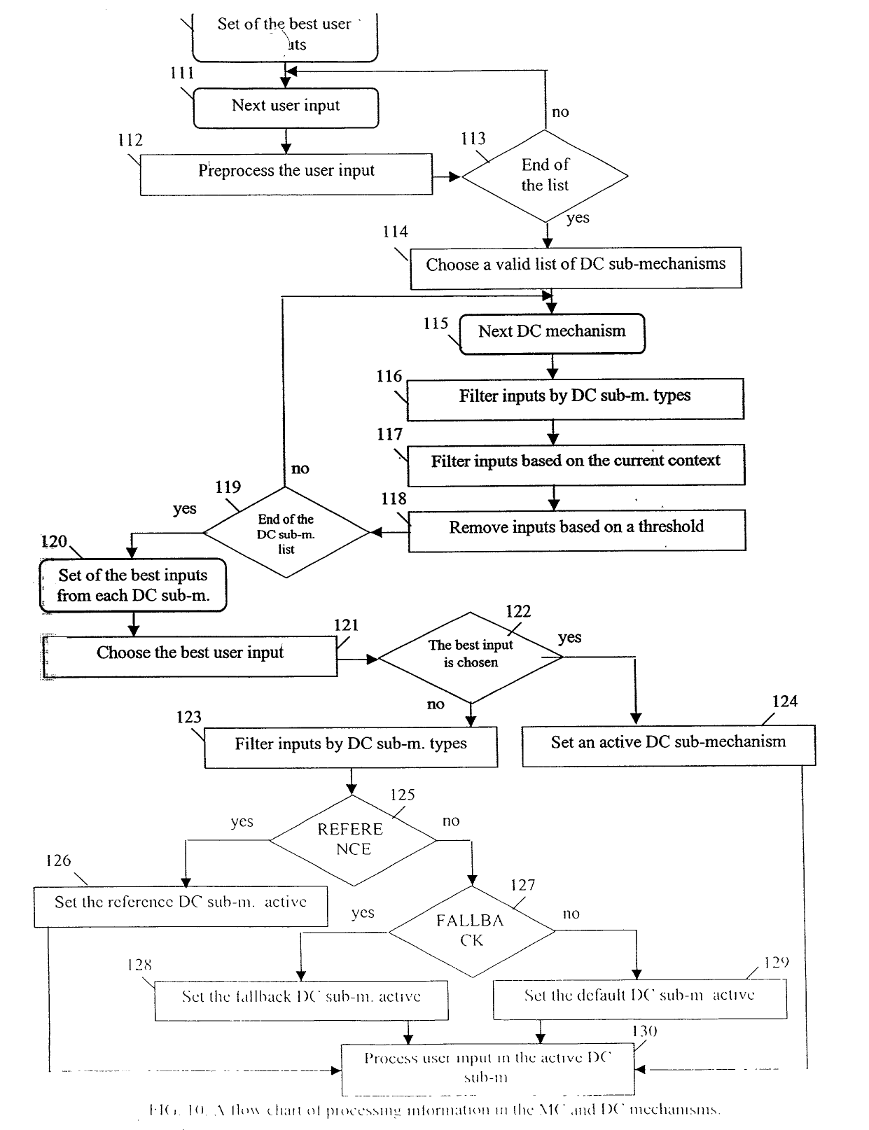

Of course, a context-related question is not the only issue involved in making an intelligent conversation, and in many cases an adequate context is not easily available. In such cases, the meta-control mechanism 14 can generate a default assumption, which is used for conducting a conversation, based upon the synthesis of its own fundamental dialogue rules and a special analysis carried out by the discourse control mechanism 15, the goal control mechanism 16, the emotion control mechanism 17. To implement its own tasks the meta-control mechanism uses a strategy of filtering the recognized and parsed user inputs with applying the conversation knowledge described by the meta-rules taken from the corresponding base, as well as a strategy of choosing the best user input. Besides, it uses a method of processing the information received from the other called mechanisms to define a system output and meta-actions. The process describing the stages of processing the information received from the pattern recognition mechanism 13 is illustrated in FIG. 10.

At the first step (steps 110-113) the set of patterns from the pattern recognition module 13 are preprocessed to eliminate extraneous possibilities. The possible patterns are sorted according to the type of topics and each user input from the set is filtered with the help of the meta-rules describing the conversation knowledge. It allows removing inputs which are not applied to a given case.

For example, the following list contains meta-filtering rules with their own dialogue-based filtering rules. These rules relate, in part, to an intention type for each phrase. The intention types relate to the expected responses from a user. For example, a REQUEST type means that the user is asking a question or seeking information. A MORE_REQUEST type means that the user is seeking additional information on the same subject. A REPY type means that the user is responding to a system question. The system responses are referred to as scripts. Scripts also have types, such as REQUEST, STATEMENT (which provides information) and MORE_STATEMENT (which provides additional information). Each rule provides a hierarchy of user types.

1. If the previous script has a REQUEST-type, an input is selected if:

a. A REPLY-type input does exist within the topic of this script of a REQUEST type and its properties are the same as those of the script.

b. A REPLY-type input does exist within the topic of this script of a REQUEST type with any set of properties

c. If no input is selected within the current topic, try the second oldest discussed topic

d. If no input is selected within the current topic, try the third oldest discussed topic

2. If the previous script is NOT of a REQUEST-type, an input is selected if:

a. An input does exist within the current topic and its properties are the same as those of the script.

b. An input does exist within the current topic with any set of properties.

c. If no input is selected within the current topic, try the second oldest discussed topic

d. If no input is selected within the current topic, try the third oldest discussed topic

3. If user input contains a context pattern and therefore should be considered only in the context of its topic or its knowledge base then it is valid only if the previous script is from the same context topic or the context knowledge base.

4. If no user input has been selected through the above-mentioned rules then the pattern with the highest matching value is returned. In this case the main strategy used for selecting the best-matching pattern is to stay within the same topic. If the previous memorized topic coincides with a topic to which the highest-matching pattern relates, then the meta-control mechanism 14 chooses this pattern. If the highest-matching pattern does not specify a topic and another pattern has almost the same matching value and refers to the previously discussed topic, then the mechanism chooses the latter expression.

5. If no unique selection is achieved through the process described above, then the process of selection is carried out at random with all actions being carried out with taking into account the information received from the other mechanisms.

Once the meta-control module 14 has preprocessed the possible patterns according to the meta-rules, underlying mechanisms are used to further process the possibilities. The discourse control mechanism 15 regulates the flow of a conversation in a human-like way and creates a set of suitable outputs corresponding to a particular input by using basic dialog rules from the discourse control rules base 6 and information from the goal control mechanism 16 and the emotion control mechanism 17.

After a set of user inputs is primarily processed, the system calls the discourse control mechanism 15 (step 114) for defining a way according to which this information will be further processed (steps 115-130). Depending upon the application in which the whole system is operating, the discourse control mechanism 15 then “plugs in” one or more appropriate discourse models in order to refine the selection of a response or question by the system, or even to radically shift the direction of the conversation if this is appropriate. The basic models are supported by the FALLBACK, REFERENCE, OBJECT sub-mechanisms and by special sub-mechanisms accounting for different models of the inputted phrase discourse analysis. The QUIZ sub-mechanism can be set as an example of special sub-mechanisms. However, amongst all the above-mentioned sub-mechanisms there can be only one default sub-mechanism. These sub-mechanisms make use of the context information and basic dialogue flags already supplied by the meta-control mechanism 14. The meta-control mechanism calls the list of the used discourse control sub-mechanisms and sorts them in the order, which is defined by the memory contents (step 114). After that for each existing sub-mechanism it filters all user inputs according to the type of discourse control sub-mechanisms (step 116) and then filters them in accordance with the current context (step 117). Next, the subsystem filters the remaining expressions to remove all user inputs having a matching value lower than a possible threshold (step 118), for example, 80% for the highest matching user input.

After this stage of information processing there appears a set of the best matching inputs 120, representing all the discourse control sub-mechanisms, which is followed by an attempt to choose the best user input from the set of the best ones (step 121,122). If such input can be chosen, then a corresponding discourse control sub-mechanism is activated (step 124). Otherwise, the received inputs are filtered in accordance with the type of the previously activated sub-mechanisms by means of the short-term memory device 4 abilities (step 123). If the best matching input corresponding to the REFERENCE discourse control sub-mechanism (steps 125,126) or the FALLBACK sub-mechanism (steps 127, 128) or any special sub-mechanism is found, then the sub-mechanism is activated for subsequent information processing. Otherwise, the OBJECT or default sub-mechanism is activated (step 129). In any case all the discourse control sub-mechanisms are activated to create a set of suitable outputs corresponding to the selected user input (step 130). Such sequence of actions allows choosing the best topic to be further discussed as well as avoiding a situation when the system does not fully understand a user phrase and there is a need to change the current topic for another one in a more human-like and reasonable way.

For instance, when the system in the form of a tutor-application and a student are involved in an intensive lesson, and suddenly the student makes a remark that is not germane to the lesson, the discourse control mechanism 15 of the considered system applies a generic model of behavior that enables the system to respond to the remark in the right manner, and then steer the conversation back to the topic. To implement this process a knowledge engineer only needs to worry about compiling the knowledge received and working out a teaching strategy which is needed for the subject matter, and does not need to worry about predicting all contingencies that can happen during a conversation.

Once a user input is determined by the meta-control mechanism 14, using appropriate discourse control sub-mechanisms, the system selects and prepares are response to the input. The meta-control mechanism 14 generates the best possible script (or response) characterized by a set of properties, taking into account the user's state (represented by the user input object), the memory, the state of the system (represented by the emotional state controlled by the emotional control mechanism 17 and the state of the goals determined by the goal control mechanism 16) and a list of the best possible answers presented by the discourse control mechanism 15 and selected by considering the correspondence of the involved emotional contents and some other rules. All possible system answers to the best user input 140 selected at the previous stage are chosen from the associated actions base 11. This choice is based on the correspondence of the attributes of the chosen input and scripts including a set of pre-defined actions, intentions of the considered input, script and the type of the activated discourse control sub-mechanism. To make the above choice the set forth below rules with pre-defined descending priorities is applied (FIG. 11, steps 141, 142).

1. If the OBJECT-type discourse control sub-mechanism is activated and user input has a REPLY-type intention or an intention which shows that the user enters some information into the system then the following outputs are generated:

A REQUEST-type output within the current topic, current emotional content and current topic properties.

A STATEMENT-type output within the current topic, current emotional content and current topic properties.

A STATEMENT-type output within the current topic, current emotional content and any properties

2. If the OBJECT-type discourse control sub-mechanism is activated and user input has a REQUEST-type intention then the following outputs are generated:

A STATEMENT or REQUEST-type output within the current topic, current emotional content and current topic properties.

A STATEMENT or REQUEST-type output within the current topic, current emotional content and any properties.

3. If the OBJECT-type discourse control sub-mechanism is activated and user input has a MORE_REQUEST-type intention then the following outputs are generated:

A MORE_STATEMENT-type output within the current topic, current emotional content and current topic properties.

A STATEMENT or REQUEST-type output within the current topic, current emotional content and current topic properties.

A MORE_STATEMENT-type output within the current topic, current emotional content and any properties

A STATEMENT or REQUEST-type output within the current topic, current emotional content and any properties.

4. If the OBJECT-type discourse control sub-mechanism is activated and user input has an intention indicating that the user repeats information or a query, then the following outputs are generated:

An output with the same type of intention as the one of the input within the current topic, current emotional content and current topic properties.

A REQUEST-type output within the FALLBACK topic, current emotional content and any properties (not more than in 40% of all cases).

An output with the same type of intention as the one of the input within the FALLBACK topic, current emotional content and current topic properties.

An output with the same type of intention as the one of the input within the FALLBACK topic, current emotional content and any properties.

5. If the OBJECT-type discourse control sub-mechanism is activated and the user input generated by the system itself has an intention which shows that there is a need to change the discussed topic to a new one then the following states are checked:

If the topic to change to is not defined then the discourse control mechanism receives a goal from the goal control mechanism 16 to choose a topic.

If the topic to change is yet to define, then the topic, which according to the statistics has been most frequently chosen, will be the topic to use.

After that, the following outputs are generated:

An output, which has an intention showing a need to leave the current topic, within the current topic, current emotional content and any properties

An output, which has an intention showing a need to change the discussed topic to a new one, within the new topic, current emotional content and any properties.

An output, which has an intention stating in a succinct way what is being discussed and possibly why, within the new topic, current emotional content and any properties.

An output, which has an intention pointing that the output can be an expression of an opinion, a “random thought”, a humorous remark, or a rhetorical question, within the new topic, current emotional content and any properties.

6. If the OBJECT-type discourse control sub-mechanism is activated and the user input generated by the system itself has an intention which shows that the context of the dialog is clear and there is a longer statement of a fact which can be a lengthy, multi-turn elucidation, then the following outputs are generated:

An output with the same type of intention as the one of the input within the current topic, current emotional content and current topic properties.

A STATEMENT-type output within the current topic, current emotional content and current topic properties.

An output with the same type of intention as the one of the input within the current topic, current emotional content and any properties.

A STATEMENT-type output within the current topic, current emotional content and any properties

7. If the OBJECT-type discourse control sub-mechanism is activated and user input has an intention showing that the system should do something then the following output is generated:

An output with the same type of intention as the one of the input within the current emotional content.

8. If the OBJECT-type discourse control sub-mechanism is activated and user input generated by the system itself has an intention indicating that there is a need to change the state of the goal control mechanism 16 concerning a definite goal, then a specified goal state is switched to the COMPLETED mode.

9. If the REFERENCE-type discourse control sub-mechanism is activated and user input has an intention of any type except for a type indicating that the system must do something or there is a need to change the state of the goal control mechanism 16 concerning a definite goal then the rules for choosing a system output are the same as those mentioned above and used for the active OBJECT-type discourse control sub-mechanism. In the last two cases these rules are ignored.

10. If the FALLBACK-type discourse control sub-mechanism is activated and user input has any type of intention except for the type showing that the user repeats the last entered information or query then the following outputs are generated:

A REQUEST-type output within the current topic, current emotional content and current topic properties (not more than in 40% of cases).

An output, which has an intention, pointing that the statement has no practical content but serves as a filler (which is sort of a response to indicate that the dialog is being conducted) in the conversation, within the current topic, current emotional content and current topic properties.

An output which has an intention, pointing that the statement has no practical content but serves as a filler in the conversation, within the current topic, current emotional content and any properties.

An output which has an intention stating in a succinct way what is being discussed and possibly why within the previous OBJECT-type topic, current emotional content and any properties.

An output which has an intention pointing that the output can be an expression of an opinion, a “random thought”, a humorous remark, or a rhetorical question within the previous OBJECT-type topic, current emotional content, and any properties.

11. If the FALLBACK-type discourse control sub-mechanism is activated and user input has an intention showing that user repeats the last entered information or query then the following outputs are generated:

An output with the same type of intention as the one of the input within the current topic, current emotional content and current topic properties.

An output with the same type of intention as the one of the input within the current topic, current emotional content and any properties.

12. If the special QUIZ type discourse control sub-mechanism is activated and user input has the REQUEST, REPLY-type of intention and a type of intention which shows that there is a need to change the discussed topic to a new one then rules for choosing a system output are the same as the above mentioned rules for the active OBJECT-type discourse control sub-mechanism.

13. If the special QUIZ-type discourse control sub-mechanism is activated and the user input generated by the system itself has an intention showing that there is a need to change the state of the goal control mechanism concerning a definite goal then the following states are checked:

If there are more QUIZ-type topics then the output with an intention showing that there is a need to change the discussed topic to a new one within the next QUIZ-type topic, current emotional content and any properties is generated.

If there are no more QUIZ-type topics left then the output with an intention showing that there is a need to change the state of the goal control mechanism concerning a definite goal within the root QUIZ-type topic, current emotional content and any properties is generated.

Next, the goal control mechanism 16 may be activated to drive the conversation towards specific goals assigned to an application of the system by using the goal control rules base 7. The goal control mechanism 16 has a set of the goal rules and a set of the goals that would be desirable to reach during a conversation. At any point in time the goal control mechanism 16 is also in a state that is determined by the state of the goals. In the system the way of introducing the goals is defined by the discourse control mechanism 15 and its discourse management rules 6. These rules determine when and how a goal from the list should be introduced. The full listing of the rules pertaining to the modules is considered further.

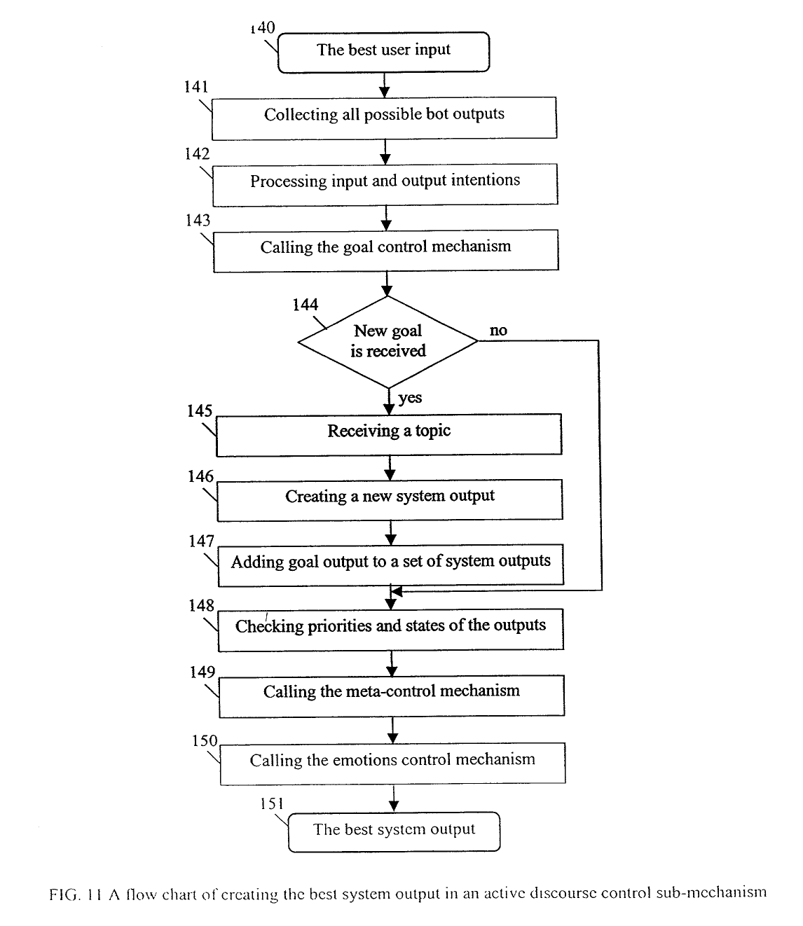

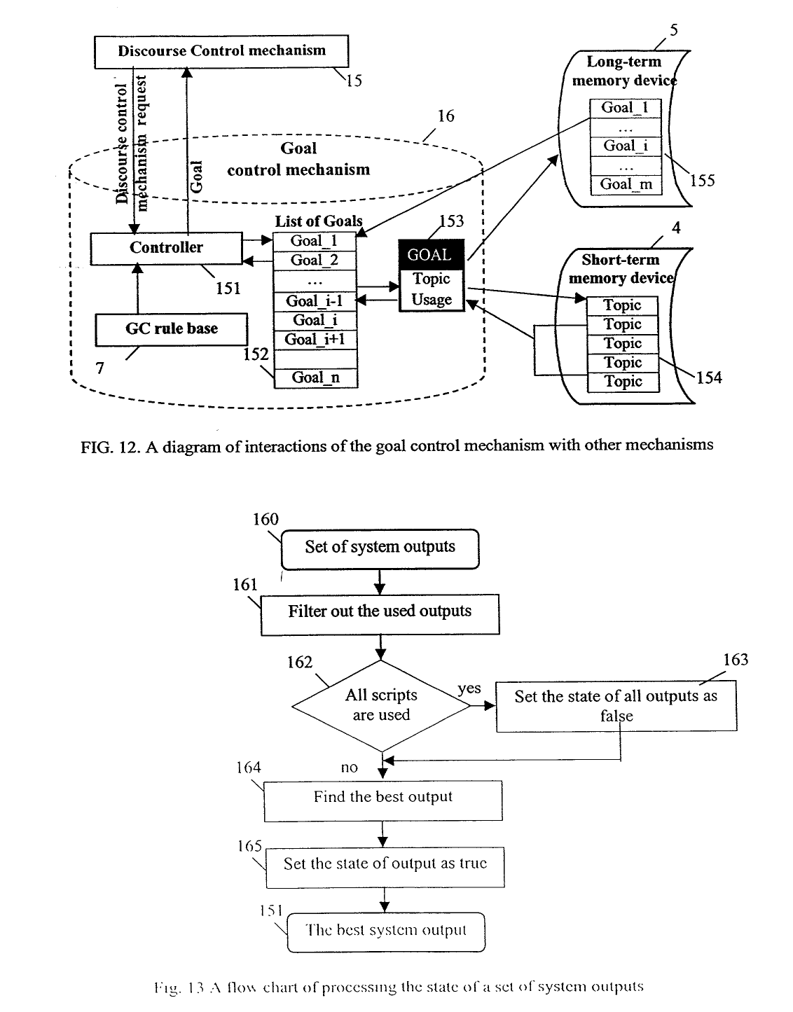

The considered rules define the choice of the best system output in case when a topic is determined by the memorized queries and information received from the user and system, but if at this stage two and more possible answers are chosen or there are some goal topics in the custom knowledge base 1-3, 11, then the discourse control mechanism 15 calls the goal control mechanism 16 to subsequently select the best answer (FIG. 11, step 143). The structure of the information used by the goal control mechanism 16 is illustrated in FIG. 12. It is necessary to notice that any topic can be defined by a knowledge engineer as a goal topic. The system can support any set of goals which are defined as a list when the knowledge base is created. The properties of the goal list such as a frequency alteration and order (sequential or random) are also defined at this stage. The sequential order for choosing goals from the list is used when the order of the goals is important within the scope of the conversation with the user. Otherwise, the random order is used. Each goal is characterized by a maximum usage parameter and state (completed or achieved, activated but not completed, and non-activated). The goal is marked as achieved only after the topic has been discussed a certain number of times which is specified uniquely for each goal as a maximum usage parameter as shown in block 153 (FIG. 12).

The goal control mechanism 16 linked to the short-term memory device 4 to maintain a set of goals 152 to be achieved and contains information about their states and usage. The goal activation process is based on the number of exchanges which the user has with the system. The activation number is selected randomly from a specified range that is defined by the frequency alteration parameter. The mechanism decides when a new goal has to be executed in accordance with the following rules from its own rules base 7:

Only a goal in an ACTIVE state can be executed.

A goal is still in an ACTIVE state as long as it is not in a COMPLETED state.

A goal state turns into a COMPLETED state if the topic has been discussed a <max usage> number of times.

A new goal has to be introduced if no goal topic has been discussed recently.

A term “recently” is defined by a range of exchanges between the considered system and the user.

When a new goal is activated, the controller 151 generates a command action being user input with an intention indicating that there is a need to change the discussed topic to a new one with the name of the new goal topic being presented as a parameter. If all goals are completed or a knowledge engineer has not created any goal topics then a topic which is used more frequently than the others becomes the goal topic. This double assignment of goals with the use of the long-term memory device 5 where the state of all goals is stored allows selecting different goal-oriented behaviors without an additional effort from a knowledge engineer. Moreover, the discourse control mechanism 15 receives a link to that topic (step 145) and creates a new system output (step 146). After that it adds this output with some priority to the existing set of system outputs (step 147) and checks the status of the pre-processed outputs (step 148). If the status of the pre-processed outputs is similar to the goal output or the goal output has a higher priority, then the discourse control mechanism 15 can either choose an answer that would satisfy the goal, or just add an appropriate goal satisfying the comment to the answer selected through other steps. Otherwise, this mechanism 15 considers only the outputs generated by means of the rules from the DC rules base 6. In other words, while pursuing the listed goals, the system becomes a proactive one.

After that this mechanism calls the meta-control mechanism 14 (step 149) which checks the state of the chosen set of system outputs. It considers the obtained set of outputs 160 taking into account their status (FIG. 13, steps 161,162). This means that it checks whether they have been used before. This information is supplied by the action retrieval mechanism 18. If it cannot find any unused outputs, then it changes their state to the opposite one (step 163). Next and in other relevant cases through step 164, to obtain the most appropriate output 151 the mechanism 15 calls the emotion control mechanism 17 (step 149) FIG. 11 and sets the state of the chosen script as a used one (step 165), changing also the state of the track of the used scripts in the action retrieval mechanism 18.

The described sequence of actions enables this system to be utilized in a plurality of cases, especially when it can be implemented as a web site guide to bring the site visitors to its key areas, which can offer new information or open previously-unvisited pages when the conversation turns to general topics, or when the customer asks for suggestions about where to go, or when the same customer pays another visit to this site.

In addition, the emotion control mechanism 17 provides sensitivity to the emotional content of the user's input by using the emotions control rules base 8. The emotion control mechanism 17 has a set of emotional behavior rules and controls the emotional state of the system, based on several types of emotions having different level in each type. The emotional state of the system is updated every time a user phrase is received for processing and every time the system answers a user phrase (depending on the user and the system3 s emotional state). The full listing of the rules pertaining to the module is given in the below paragraphs.

After being called the emotions control mechanism 17 implements a behavior model of the system which allows defining and regulating the transition of the states of the system in a more human-like way taking into account the influence of user inputs and scripts taken from the bases of patterns and actions. The mechanism maintains a set of primary emotions of the system which includes, on average, four antagonistic pairs. The primary emotions of the system, called emotion markers (D), are characterized by Eᵢ states with each being assigned a numerical value that represents the level of activation of a particular state. For instance, if the emotion “joy” has a high value, then the corresponding antagonistic emotion “sadness” may be assigned a low value.

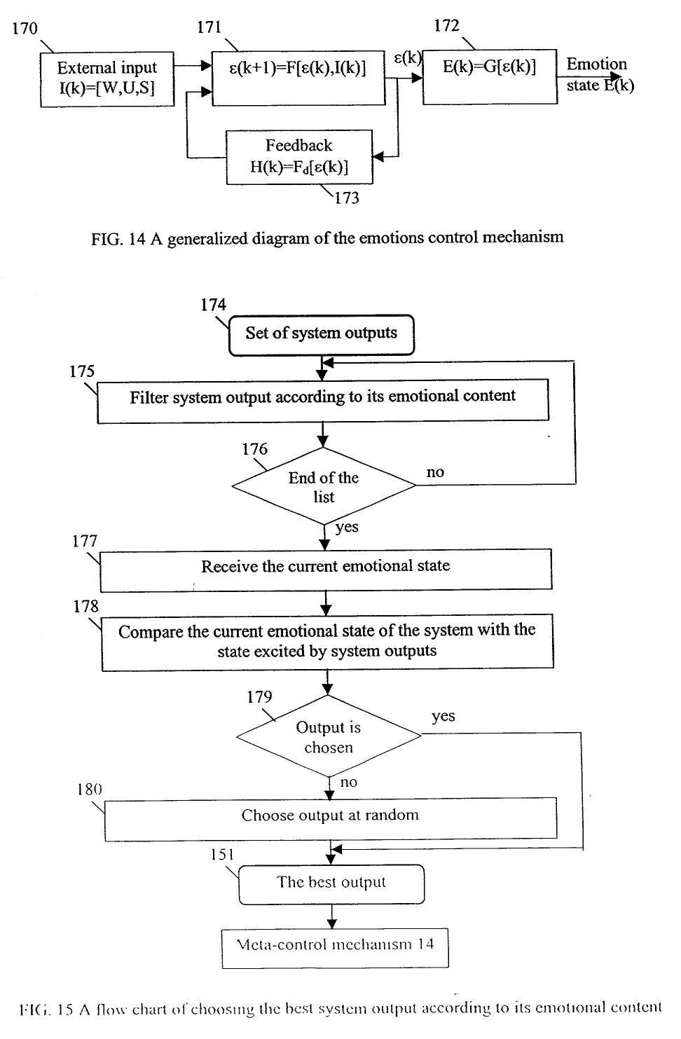

The diagram of a generalized emotions control mechanism is shown in FIG. 14. The emotional state of the system implemented in the form of an application, for example, for the Internet, may be influenced by its past emotions (i.e., if it has been happy in the last few dialogues) or system actions S, a user's phrase U (for instance if he/she is abusive), and external data W (such as a large change in stock prices in case of a portfolio-specialization). These elements are shown as a part of the external input step 170 in FIG. 14. The state of the system may be defined by the set of emotions and other variables such as the context of the conversation M, information about which is sent by the meta-control mechanism 14 and the discourse control mechanism 15 (step 171). The state of the system is transformed into a new one under the influence of inputs which results in the activation level change of the primary emotions (step 172). The effect of the past context and emotions is covered by the feedback step 173. The functions F[ε(k),I(k)], G[ε(k)], F_{d}[ε(k)] are the internal rules of the mechanism and in a particular case of implementation are decomposed into the first order differential equation representing the evolution of emotional states Eᵢ:

dE/dt=f_{U}(D_{U})+f_{S}(D_{S})+f_{M}(D_{M})+f_{d}(E)

where E and D are multidimensional vectors, and all f are functions of the corresponding parameters.

One of the considered rules specifies the internal dynamics of the states, such as decay values over time (f_{d}) for a specific emotion when it is rarely activated. If emotion E₁ has a high value at a specified time t, then its values fall over time while there are no persistent input stimulus to drive the system to emotion E₂ as a result of the equation containing f_{S}. The emotional state of the system is updated every time a user phrase is received for processing and every time the system answers a user phrase, but the emotional state of the system while it is answering is built to be similar to the user's emotional state. The initial (zero) emotional state of the system is referred to as the neutral state. It should be noted that the exact view of the rules for processing the emotional content could be customized, because initially they are defined by scalar functions. This ability allows providing a more precise understanding of a human emotion and changing the content of knowledge bases for different applications without strong efforts from a knowledge engineer. In an uncustomized state, the emotions control mechanism 17 employs a specialized, built-in knowledge base for analyzing the emotional substance of every user input.

The mechanism filters the set of system outputs 174 received from the goal control mechanism 16 to isolate outputs having a neutral emotion content and sorts the remaining ones according to a predefined order (steps 175, 176 in FIG. 15). After that it receives the evaluation of the system current emotional state (step 177) and compares it with the ordered list of the emotional states activated by the set of system outputs (step 178). The sub-system chooses one output from this set provided the emotional state of the output is the closest to the current emotional state of the system (steps 179, 180). If no emotional content has been defined, an answer is chosen by means of following rules (steps 179, 151, FIG. 15):

Select a script from the list at random.

Select the next script from the list.

Select the next script that has not been taken from the list yet.

Select the script executed the least number of times.

This approach is especially important when the system tries to choose the best script out of several possible ones, provided that all other properties and priorities are the same. Then, if necessary, this information is supplied back to the meta-control mechanism 14, for a possible modification of the system behavior, in other cases this information is ignored.

Being the central element of the system the meta-control mechanism 14 collects all the analytic information provided by the other components of the above system, and produces output, which can be considered the best one at this stage of the information processing, but it can be also considered a raw one, because it can include actions which can be directed to a variety of channels depending upon the application of this system and upon the final output modification carried out by the output interface 19. This generalized system response can include two types of actions:

1. Literal actions that are user-defined actions and which are directly generated or played by the output generator. They can be of but not limited to any sequences or combinations of the following actions:

Textual outputs generated and played by a text player which also formats, substitutes and performs some other actions.

Audio-visual animation sequences handled by an animator which also controls visual appearance, movement, gestures, expressions, and sound effects of an animated character that is used for implementing a more convenient way of a conversation.

Html content processed by the web content generator in a browser.

2. Meta-actions that are directives or internal commands for the meta-control mechanism 14 in order to change the current flow of a conversation. The list of possible commands corresponds to the set of script (output) intentions. Through the meta-actions a script can redirect the meta-control mechanism to select alternative actions or topics. The Meta actions can be initiated directly from the associated actions base 11 or by the goal control mechanism. In the first case the intention of an action and its parameters are defined in the corresponding Script. The second case relates to a more complicated behavior of the whole system. The dynamics of the process is defined by a periodical call of the goal control mechanism 16 with the help of a query about the active goals available. If the mechanism “decides” that a certain goal must be introduced but the state of this goal is marked as completed, then it generates a meta-action and sends it to the meta-control mechanism 14 which initiates a new search of the best system output.

The actions retrieval mechanism 18 delivers preliminary responses of the system from the meta-control mechanism 14, for example, in the form of a text, references to web pages, javascript actions, animations, sound, video sequences, run-time results of data input from external sources and so on, to the output interface 19. At the last step the action retrieval mechanism 18 receives an appropriate Script from the meta-control mechanism 14 and retrieves the corresponding actions of the system 21 from the associated actions base 11 and through the output interface 19 delivers the answer of the system to the user. At the same time once chosen a script is marked as a used one and can be chosen again provided all the scripts matching the system's response are also marked as used.

Once the script has been derived by the meta-control mechanism 14, the actions retrieval mechanism 18 retrieves a set of appropriate actions from the associated actions base 11. The mechanism also provides the meta-control mechanism 14 with the feedback information, describing what the system is saying or doing. This mechanism uses the following strategies for the subsequent processing of the chosen set of actions:

Finding the script that matches the specification defined by the meta-control mechanism 14. If there is a variety of scripts matching the specifications then one of them is chosen at random.

Keeping track of the previously used scripts.

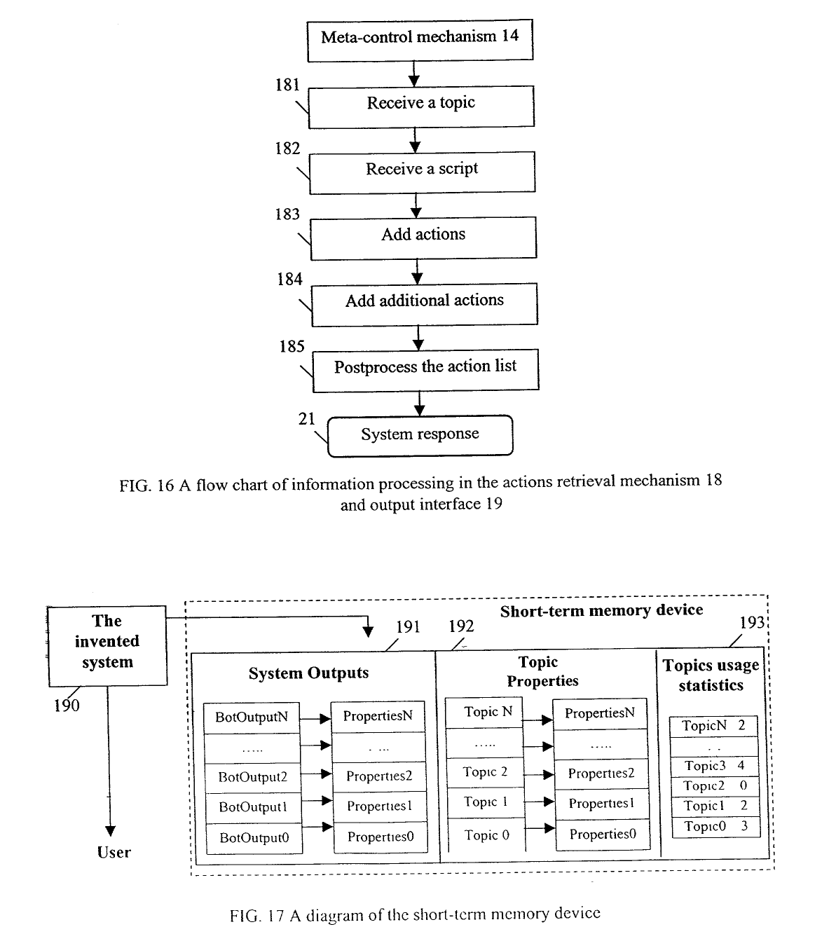

The process of information collection and transformation in this module is shown in FIG. 16. While the topic and the script of the system action are being passed to the action retrieval mechanism 18 through steps 181, 182, the mechanism itself carries out an action or actions associated with this specified topic in accordance with the specified script taken from the associated actions base 11 (step 183). After that it can change the number of actions by adding extra actions initiated by other mechanisms of the system (step 184). If there are multiple actions under the same topic and script, the mechanism prepares them to be subsequently executed.

Next, the set of actions contained in the appropriate script is post-processed. At this step some specific cases are processed and/or actions are translated by the output interface 19 into the format that can be understood by the client application (step 185).

The output interface 19, in turn, brings a generalized response of the system to the user through a variety of clients via http, or a multimedia-enabled character, which incorporates, for instance, client-side speech synthesis integrated in a windowless animated character.

All the above-described mechanisms and sub-systems address to the information storing mechanism 20 in one form or another. This mechanism is divided into two subsystems depending upon the time needed to store the conversation information. The first subsystem stores some information during the conversation and provides abilities to remember the names and personal facts about the user participating in the current conversation, to look for patterns such as repetitions by the user or look for user input that is focused on a specific topic, to determine the context of the user input taking into account the previous inputs and outputs of the whole system and so on. The set forth below information is the information which is obligatory to store in the short-term memory device shown in FIG. 17:

A list of X last system outputs, where X is the capacity or depth of the stack (step 191).

A list of properties for each used topic (step 192).

A list of the topic statistics (step 193). The topic statistics is a figure indicating the number of times the responses from the topic have been used. The statistics for all the topics is calculated every time system output is sent to the stack of the short-term memory device 4.

The information storing mechanism 20 includes the short-term memory device 4, organized in the form of a stack for the subsequent last-to-first analysis of the user's inputs and answers of the system, and the long-term memory device 5 in the form of a user profile on the server side. The pattern knowledge bases 1-3 store information about the pre-defined internal information segments distributed according to the topics with the information being parsed and compiled from usual knowledge base source files created by knowledge engineers and including indications of the pre-defined information domains. The associated actions base 11 stores information about information domains according to the references from the pattern knowledge bases 1-3, with the information being presented to the user in a form predefined by a knowledge engineer. The behavior of each above-described subsystem is defined by a combination of rules taken from the rule base of an appropriate subsystem and by the used methods which form a general information processing method. Each rule base is divided into two parts: an unchangeable part defining interaction of the present subsystem with other sub-systems and a partially changeable one defining methods for information processing in it. The latter part can be customized in accordance with the requirements for an application, but in any case it includes some rules defining basic methods for information processing in this step.

The short-term memory device 4 contains statistics about the used topics, the previous answers by system and the information about the previous conversation. The content of this device is deleted when the session is closed. The information is stored in the form of attributes pairs (“name-value”) for every used topic. The statistics are used for providing information about the discussed topics to the goal control mechanism 16 to update the state of the goals. The memorized answers of the system help define a higher priority for the last used topic in comparison with the other topics while looking for the next and most appropriate answer of the system. It also helps take into account the previous intentions and properties. The topic attributes are also used for keeping in memory some particular pieces of information about the current topic such as names, numbers, etc. that can be later applied to the future answers of the system.

The memorized topic properties are the properties of all the scripts and selected user inputs of this topic which were used during the conversation. Every time a script is chosen, the topic properties are updated: new properties are added and values of the existing properties are changed. The topic properties are usually used in the conversation.

The second subsystem called the long-term memory device 5 allows storing information for a long period of time. This enables the system, for instance, to recognize the user who participated in a previous conversation, to store the track, frequency and related statistics of the topics which were discussed in the previous conversations, to keep a list of the recent system outputs, goals, and history of the system emotional state changes, to maintain a database of specific replies that are later searched to extract specific information and so on.

Thus, this ability to log in and maintain records of the past conversations and related data enables the system to generate the statistics which is useful for user profiling and to conduct a more “responsive” and “intelligent” conversation.

The above functionality enables the system to be used in many applications utilized in different fields of the art. Besides, dynamic loading of separate topics from the divided knowledge base 1-3,11 makes the information processing less time-consuming and, thus reduces the system reaction time which enables the above system to work in the form of a real-time application. Moreover, the structure of the used rule base for each mechanism, divided into the skeleton part and customized part, allows adjusting the behavior of the whole system in accordance with its application without an application programmer's strong efforts which considerably simplifies the process of the system customization.

The considered procedure of transformation a user's phrase 00 into a response by the system 21 shows a structural simplicity of the system, having the same functional modules as a human has, and a strong dependency of functionality of all modules upon the filling of their rules bases. So, the structure of each module, its rules base and method of information processing is considered further in detail which, however, does not set any limits for the domain of the invention, because all the system mechanisms except for the meta-control mechanism 14 and discourse control mechanism 15 can be customized according to a wide range of needs.

Additionally, the system can be made more flexible provided voice recognition and speech synthesis hardware and software, rather than only graphical ware, is used in it. In such an embodiment, a user can enter his/her information or query verbally and receive an adequate system response, which can be represented only in a verbal way or in a combination of this verbal response and a graphical representation which would be understood by those reasonably skilled in the relevant arts. In order to allow the system to understand the user and respond in the ways appropriate interfaces must be built in the preprocessor 12 and the mechanism carrying out functions of the output interface 19.

The overall structure described above represents one embodiment of the invention. Having described at least one embodiment, variations, modifications and improvements will be instantly apparent to those of an ordinary skill in the art. Such variations, modifications and improvements are considered part of the present invention, which is only limited by the appended claims.

We claim:

1. A system for interactive dialog management comprising:
a pattern recognition module identifying elements in an input phrase and locating matching patterns in pattern knowledge bases;
a discourse control module for regulating a conversation flow in a human-like way and creating a set of suitable outputs corresponding to a particular input based upon the matching patterns and stored goals and emotional information;
an output interface providing the response of the system to the user; and
a meta-control module for coordinating work managing the context of a dialog by using information from the discourse control module.
